(19) United States
(12) Patent Application Publication
(10) Pub. No.: US 2026/0181024 A1
(43) Pub. Date: Jun. 25, 2026

(54) CONSOLIDATED ALERT REMEDIATION USING LARGE LANGUAGE MODELS AND GRAPH STRUCTURES

(71) Applicant: Palo Alto Networks, Inc., Santa Clara, CA (US)

(72) Inventors: Ajaya Neupane, San Jose, CA (US); Alok Tongaonkar, San Jose, CA (US)

(21) Appl. No.: 19/001,052

(22) Filed: Dec. 24, 2024

(51) Int. Cl. H04L 9/40; G06F 40/174; G06F 40/186; G06F 40/40

(52) U.S. Cl. CPC H04L 63/20; G06F 40/174; G06F 40/186; G06F 40/40

(57) ABSTRACT

A policy violation remediation system (“remediation system”) generates consolidated remediation actions for policy violations across related assets. Based on identifying related assets in a query from a user, the remediation system retrieves sets of remediation actions for remediating policy violations at those related assets. The remediation system then generates a consolidated graph structure representing a deduplicated version of the sets of remediation actions that preserves ordering. The remediation system engages a response large language model (LLM) and an evaluation LLM in a feedback loop for generating a consolidated set of remediation actions based on the consolidated graph structure. The remediation system then validates and presents the consolidated set of remediation actions to the user.

### BACKGROUND

The disclosure generally relates to managing cybersecurity alerts using machine learning (e.g., CPC subclass G06F and CPC subclass G06N 20/00).

A “Transformer” was introduced in VASWANI, et al. “Attention is all you need” presented in Proceedings of the 31st International Conference on Neural Information Processing Systems on December 2017, pages 6000-6010. The Transformer is a first sequence transduction model that relies on attention and eschews recurrent and convolutional layers. The Transformer architecture has been referred to as a foundational model, and there has been subsequent research in similar Transformer-based sequence modeling. Architecture of a Transformer model typically is a neural network with transformer blocks/layers, which include self-attention layers, feed-forward layers, and normalization layers. The Transformer model learns context and meaning by tracking relationships in sequential data. Some large language models (LLMs) are based on the Transformer architecture. An LLM is “large” because the training parameters are typically in the billions. LLMs can be pre-trained to perform general-purpose tasks or tailored to perform specific tasks. Tailoring of language models can be achieved through various techniques, such as prompt engineering and fine-tuning. For instance, a pre-trained language model can be fine-tuned on a training dataset of examples that pair prompts and responses/predictions. Prompt-tuning and prompt engineering of language models have also been introduced as lightweight alternatives to fine-tuning. Prompt engineering can be leveraged when a smaller dataset is available for tailoring a language model to a particular task (e.g., via few-shot prompting) or when limited computing resources are available. In prompt engineering, additional context may be fed to the language model in prompts that guide the language model as to the desired outputs for the task without retraining the entire language model or changing the weights of the language model.

Applications that use foundation models have combined the use of a foundation model with retrieval augmented generation (RAG). RAG augments a query/prompt with context, in the form of embeddings, from an authoritative data source external to the foundation model. This separation allows for the authoritative data source to be more efficiently updated than updating knowledge of the foundation model and facilitates dynamic augmentation of a prompt with current context for a domain(s) represented by the authoritative data source. The RAG technique generates an embedding(s) from the prompt and retrieves similar embeddings from the authoritative data source. With the prompt and similar embeddings, the foundation model generates a retrieval augmented output that has been shown to be more accurate and context-relevant than without RAG.

### BRIEF DESCRIPTION OF THE DRAWINGS

Embodiments of the disclosure may be better understood by referencing the accompanying drawings.

FIG. 1 is a diagram of an example system for remediating security policy violations using consolidated graph structures and LLMs to generate consolidated sets of remediation actions and corresponding scripts.

FIG. 2 is an illustrative diagram of example sets of remediation actions, example graph structures representing the sets of remediation actions, an example consolidated graph structure, and an example consolidated set of remediation actions.

FIG. 3 is a flowchart of example operations for performing consolidated remediation of policy violations.

FIG. 4 is a flowchart of example operations for generating a consolidated graph structure representing sets of remediation actions.

FIG. 5 is a flowchart of example operations for validating a consolidated set of remediation actions and converting a first script to a target scripting language.

FIG. 6 depicts an example computer system with a policy violation remediation system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Alert remediation across an organization poses a logistical challenge due to varying security policies configured for assets of various types. The alerts can be high in volume and of varying severity/triage levels, assets can have varying cloud service providers (CSPs), and there is often redundancy in remediating alerts for sets of related assets having similar types, security policies, CSPs, etc. Moreover, a same action may only need to be performed once across multiple alerts for remediation purposes. The present disclosure leverages graphs structures that represent ordered sets of remediation actions across related alerts as well as LLMs to both generate consolidated sets of remediation actions to be performed across multiple alerts and to generate scripts that can be executed to perform the consolidated sets of remediation actions.

Based on receiving a user query for policy violation remediations for one or more assets, a policy violation remediation system (“remediation system”) parses the user query to identify related assets/policies and retrieves sets of remediation actions for each policy violation. A graph structure generator generates a compressed graph structure that preserves sequential ordering of remediation actions across the sets of remediation actions while compressing redundant remediation actions into single nodes. A prompt generator then populates a first prompt template with the consolidated graph structure and related example scripts to generate a first prompt for a response LLM. The first prompt template comprises task instructions to generate a consolidated set of remediated actions and corresponding script that performs the consolidated set. The prompt generator prompts the response LLM with the first prompt to obtain a consolidated set of remediation actions and corresponding script. The prompt generator then populates a second prompt template comprising task instructions to evaluate the outputs of the response LLM to generate a second prompt, then prompts an evaluation LLM with the second prompt. Based on whether an evaluation output by the evaluation LLM indicates that the consolidated set of remediation actions and corresponding script pass, the prompt generator either updates the first prompt and re-prompts the response LLM (in the event of a fail) or forwards the consolidated set of remediation actions and script to a validation module (in the event of a pass) that formats and communicates the consolidated set of remediation actions and script to the user. When the outputs of the response LLM fail evaluation by the evaluation LLM, the response LLM and the evaluation LLM enter a feedback loop of updating prompts to the response LLM until its outputs pass evaluation. This remediation system reduces manual labor involved in implementing redundant security policy remediations across assets/policy violations and generates scripts for users when the users may not be familiar with the format/language of scripts for security policy violations, further reducing manual labor in familiarization with each scripting language.

### Example Illustrations

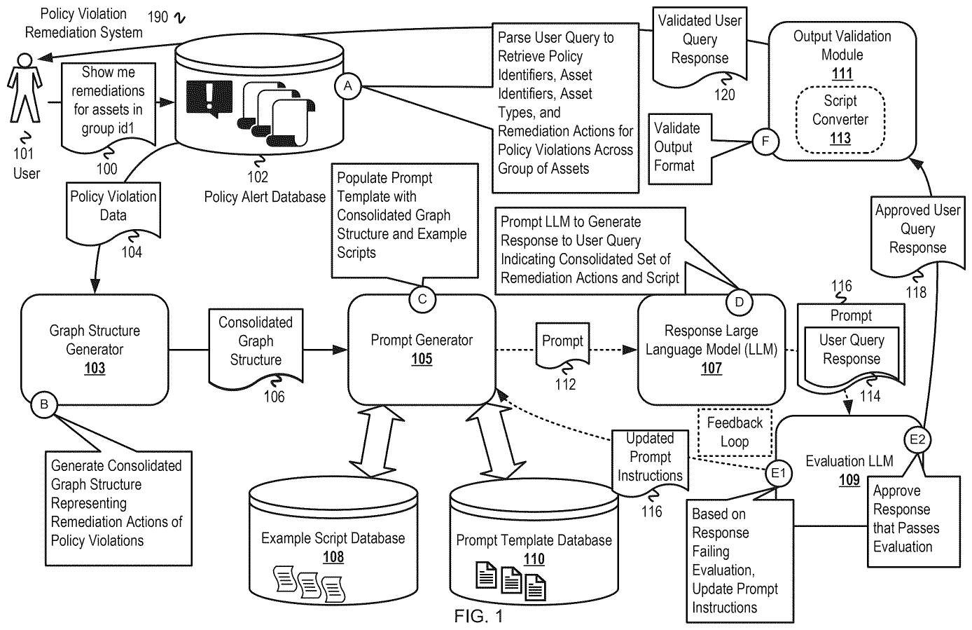

FIG. 1 is a diagram of an example system for remediating security policy violations using consolidated graph structures and LLMs to generate consolidated sets of remediation actions and corresponding scripts. A policy violation remediation system (“remediation system”) 190 receives user queries and searches a policy alert database 102 for policy identifiers, asset identifiers, asset types, and sets of remediation actions for policy violations across sets of assets associated with each user query. The policy alert database 102 comprises a centralized storage of sets of remediation actions for all policy violations and corresponding metadata across a scope of assets (e.g., an organization, a branch location, a region, etc.). The policy alert database 102 can have an index of sets of remediation actions for each type of policy violation, for instance sets of remediation actions written by a domain-level expert. As policy violations are detected and indications thereof are communicated to the policy alert database 102, the policy alert database 102 can match each detected policy violation with a corresponding set of remediation actions using the index prior to storage. The remediation system 190 forwards this data to a graph structure generator 103 that generates consolidated graph structures from the sets of remediation actions for each user query. A prompt generator 105 retrieves and populates corresponding prompt templates with the consolidated graph structures and example scripts and prompts a response LLM 107 to generate responses to user queries. The response LLM 107 then engages in a feedback loop with an evaluation LLM 109, wherein the evaluation LLM 109 is prompted to evaluate responses generated by the response LLM 107. For a successful response, the evaluation LLM 109 forwards the response to an output validation module 111 and, for a failed response, updates prompt instructions for the response LLM 107 to improve response quality. Based on receiving a successful response, the output validation module 111 ensures the response has the appropriate format and, when applicable, converts the type of script therein and then communicates the validated response to a corresponding user.

FIG. 1 is annotated with a series of letters A, B, C, D, E1, E2, and F representing stages of operations, each stage corresponding to one or more operations. E1 and E2 represent stages of operations for different possible outcomes during a feedback loop between the response LLM 107 and the evaluation LLM 109, with E1 occurring for response failure and E2 occurring for response success. Although these stages are ordered for this example, the stages illustrate one example to aid in understanding this disclosure and should not be used to limit the claims. Subject matter falling within the scope of the claims can vary from what is illustrated.

At stage A, the remediation system 190 receives a user query 100 from a user 101 at a user interface (UI) (not depicted) and parses the user query 100 to identify a group of related assets. The remediation system 190 then queries the policy alert database 102 for, for each policy violation among the group of related assets, policy identifiers, asset identifiers, asset types, and a set of remediation actions. Asset types can include Amazon Web Services® (AWS) EC2 instances, Internet of Things (IoT) assets, Identity and Access Management (IAM) assets, virtual machines (VMs), containers, databases, etc. The policy alert database 102 can manage policy alerts for all assets across an organization associated with the user 101. In some embodiments, the UI for the user 101 can present a UI element that allows for selection of an asset or group of assets (e.g., a dropdown menu). In other examples, when the user query comprises natural language, the remediation system 190 can utilize an LLM to identify a group of related assets indicated in the user query 100 by group identifier, asset identifiers, etc. The user query 100 comprises the example text, “Show me remediations for assets in group id1”. The user query 100 can additionally specify types of security policies to remediate, and the retrieved policy violations and related data from the policy alert database 102 can comprise policy violations for security policies of the specified types. The remediation system 190 aggregates the retrieved data as policy violation data 104 and communicates the policy violation data 104 to the graph structure generator 103.

At stage B, the graph structure generator 103 generates a consolidated graph structure 105 from the policy violation data 104 that represents sets of remediation actions across policy violations while deduplicating redundant remediation actions. Each set of remediation actions for a policy violation in the policy violation data 104 comprises a set of actions, wherein each action can have sub-actions to perform for its completion. When generating the consolidated graph structure 105, the graph structure generator 103 initializes an empty graph structure and, starting at a first set of remediation actions, starts adding nodes to the graph structure corresponding to remediation actions based on the order of appearance in the set of remediation actions. For each current remediation action during generation of the consolidated graph structure 106, the graph structure generator 103 checks whether the current remediation action already corresponds to a node in the graph structure. If the remediation action is already present in the graph structure, the graph structure generator 103 associates the remediation action with that node, and otherwise the graph structure generator 103 initializes a new node with a label comprising the description of the remediation action. If the current remediation action is not the first remediation action in its corresponding set of remediation actions, the graph structure generator 103 adds a directed edge in the graph structure from a node corresponding to the previous remediation action in the set (i.e., the immediately preceding remediation action if the current remediation action is not a sub-action, and otherwise the remediation action to which the current remediation action is a sub-action) pointing at the node for the current remediation action. The graph structure generator 103 iterates sequentially through remediation actions in each set of remediation actions to populate the graph structure as the consolidated graph structure 106 until it exhausts remediation actions. The resulting consolidated graph structure 106 is a directed acyclic graph. The graph structure generator 103 flattens the consolidated graph structure 106 to obtain a representation that can be added to a prompt. The graph structure generator 106 performs a breadth-first search (BFS) (or depth-first search (DFS) or other graph search algorithm) of nodes in the consolidated graph structure 106 and, for each node in the BFS according to order visited, adds a remediation action description indicated at that node to obtain the flattened representation. The consolidated graph structure 106 deduplicates redundant remediation actions occurring across policy violation remediations, which will inform the response LLM 107 on how to consolidate remediation actions across the policy violations.

At stage C, the prompt generator 105 retrieves and populates a prompt template with the consolidated graph structure 106 and example scripts to generate a prompt 112. The prompt generator 105 queries a prompt template database 110 with first characteristics of assets indicated in the policy violation data 104 (e.g., a cloud service provider (CSP) of the assets) and the prompt template database 110 returns a prompt template corresponding to these first characteristics (e.g., corresponding to the CSP). The prompt generator 105 then queries an example script database 108 with second characteristics of the assets indicated in the policy violation data 104 (e.g., one or more types of the assets) and the example script database 108 returns most relevant scripts to the second characteristics (e.g., according to an index by characteristics maintained at the example script database 108). The following text is an example prompt template retrieved from the prompt template database 110 (where the consolidated graph structure 106 is inserted into the “““+flattened_remediation_actions+””” field and the “[ ]” syntax represents the list of remediation action descriptions from the policy violation data 104):
Persona/Role/Vision: Be an expert remediation actions summarizer. Make sure the actions you are summarizing are not repeated, and not missed.
Mission/Goal: Remove the redundant actions from the policy remediations and generate a combined set of actions in order.
Instructions/Task: You are given the context with the remediation actions. You will be asked to summarize remediation actions.
Given the context with remediation actions for enumerated policies, generate minimal distinct valid actions.
Identify and merge overlapping actions to create a concise set of remediation actions applicable to all policies.
You will find the labels for policy remediations in the [ ].
Ensure you are merging with appropriate “and”, “or”, and “not” grammar of computer science when merging actions.
Tone: Be technical.
Safeguards: Do not generate actions outside the ones provided in the context. Print the label of the finding type for which you are generating actions in [ ].
Context: “““+flattened_remediation_actions+”””
Guardrails/Constraints: Ensure you are following the correct order to complete the actions.
Do not repeat actions.
“Log in” and “Sign in” means same thing.
“PUBLIC ACCESS” and “INTERNET EXPOSURE” means same thing.
Merge actions and pick all the actions needed.
If the finding type is not provided, you need to consolidate all the provided actions for all the findings in one group.
Ensure you think and generate action by action.
Output Format: Enumerate actions.
The prompt template for the response LLM 107 can additionally comprise task instructions to generate a script for a specified language (e.g., a script for the AWS Command Line Interface (CLI)). The task instructions can describe the scripting language, specify syntax for the scripting language, and provide the example scripts returned from the example script database 108 for guidance.

At stage D, the prompt generator 105 prompts the response LLM 107 with the prompt 112 and the response LLM 107 outputs a user query response 114 in response. The user query response 114 indicates a consolidated set of remediation actions to perform to resolve policy violations indicated in the policy violation data 104 and a script that performs the consolidated set of remediation actions when executed. The response LLM 107 (or the prompt generator 105 or other management component of the remediation system 190) then populates a prompt template for the evaluation LLM 109 with the user query response 114 to generate a prompt 116 and communicates the prompt 116 to the evaluation LLM 109. The operations at stage E1 occur if output of the evaluation LLM 109 indicates the user query response 114 is not correct (evaluation failure) and the operations at stage E2 occur if output of the evaluation LLM 109 indicates that the user query response 114 is correct (evaluation success).

An example prompt template for the evaluation LLM 109 comprises the following text:
Persona/Role/Vision: Be an expert Examiner in Summarization of Multiple Actions. Each action is an action in AWS.
Mission/Goal: Ensure summary covers all the actions as expected.
Tone: Be technical.
Safeguards: Ensure the output does not contain significant amount of new content.

Context: Remediation Policies: “““ + prompt + ”””
<Summary> “““ + output + ”””
</Summary>

Output Format: Give new output, and what you fixed.
Instructions/Task: We have provided you the prompt and the relevant output we got.
Now, look at the summarized actions and check if actions is correct.
If some relevant actions are missed, or if the output contains information other than what was asked, provide what needs to be fixed.
Guardrails: Do not generate scripts if you do not know how to fix the scripts.

At stage E1, based on the user query response 114 failing evaluation by the evaluation LLM 109 as indicated in output of the evaluation LLM 109, the evaluation LLM 109 communicates updated prompt instructions 116 from its output to the prompt generator 105. The prompt generator 105 then updates the prompt 112 and re-prompts the response LLM 107. The evaluation LLM 109 again evaluates user query responses generated by the response LLM 107. Response generation and response evaluation occurs in a feedback loop (indicated by the dashed line in FIG. 1) between the prompt generator 105, the response LLM 107, and the evaluation LLM 109 until evaluation success or a timeout trigger (e.g., a threshold number of iterations) occurs. In the event of a timeout trigger, the evaluation LLM 109 communicates a default response to the user 101 indicating that a consolidated set of remediation actions could not be generated for policy violations of the assets indicated in the user query 100. The default response can additionally provide each of the sets of remediation actions for each of the policy violations instead of a consolidated set of remediation actions.

Example output of the evaluation LLM 109 in the event of evaluation failure comprises the following text:

### Provided Summary:

1. Log in to the AWS console
2. Navigate to the relevant service (e.g., Lambda Function, EC2 instance, S3)
3. Find the role used by the relevant entity (e.g., Lambda Function, EC2 instance, Okta user)
4. Navigate to the IAM service
5. Click on Roles
6. Choose the relevant role
7. Under “Permissions policies”, find the relevant policy according to the alert details
8. Remove the risky actions according to the alert details after correction!
   The output is missing the following actions:
1. Navigate to the compute service (For example, AWS EC2, AWS Lambda, or AWS ECS) or login to the Okta console
2. Find resource-based policy of the resource
The output also contains the following unnecessary information:
“e.g., Lambda Function, EC2 instance, S3”
“e.g., Lambda Function, EC2 instance, Okta user”

An example corrected user query response generated by the response LLM 107 as part of the feedback loop comprises the following:
1. Log in to the AWS console
2. Navigate to the relevant service
3. Find the role used by the relevant entity
4. Navigate to the IAM service
5. Click on Roles
6. Choose the relevant role
7. Under “Permissions policies”, find the relevant policy according to the alert details
8. Remove the risky actions according to the alert details
9. Navigate to the compute service (For example, AWS EC2, AWS Lambda, or AWS ECS) or login to the Okta console
10. Find resource-based policy of the resource

At stage E2, the evaluation LLM 109 approves the user query response 114 and communicates an approved user query response 118 to the output validation module 111. The output validation module 111 validates a format of the approved user query response 118. For instance, the output validation module 111 can verify that the consolidated set of remediation actions in the approved user query response 118 comprises an ordered list of remediation actions.

At stage F, the output validation module 11 validates format of the approved user query response to obtain a validated user query response 120. The output validation module 111 can comprise a script converter 113 (indicated as optional by the dashed outline) that converts scripts in the approved user query response 118 from a first scripting language (e.g., scripts for AWS CLI) to a second scripting language (e.g., a Terraform® script or other infrastructure-as-code script). The script converter 113 can comprise a converter LLM and an evaluator LLM that act in a feedback loop similar to the response LLM 107 and the evaluation LLM 109. An example prompt for the converter LLM comprises the following text (where the script in the user query response 118 is inserted into the “““+fix_aws_cli+””” field and example scripts retrieved from the example script database 108 in the second scripting language are inserted into the “““+few_shot_examples+””” field):
Persona/Role/Vision: Be an expert in Terraform. Terraform allows you to create, update, and version your Amazon Web Services (AWS) infrastructure.
Mission/Goal: Look at the examples and generate terraform script for the given AWS CLI.
Tone: Be technical.
Safeguards: Do not generate texts outside the terraform script.

Context: CLI Script: “““ + fix_aws_cli + ”””
“““ + few_shot_examples+ ”””

Output Format: Terraform Script
Instructions/Task: Given an AWS CLIin the context, generate a terraform script. Use new-style interpolation syntax.
Guardrails: Do not generate scripts if you do not know how to.

An example prompt for the evaluator LLM that evaluates converted scripts comprises the following text:
Persona/Role/Vision: Be an expert Examiner in Terraform. Terraform allows you to create, update, and version your Amazon Web Services (AWS) infrastructure.
Mission/Goal: Look at the terraform script and check if terraform script for the given aws cli.
Tone: Be technical.
Safeguards: Do not generate texts outside the terraform script.

Context: CLI Script: “““ + fix_aws_cli + ”””
<Terraform> “““ + output + ”””
</Terraform>

Output Format: New Terraform Script, if the old is wrong. And what you fixed.
Instructions/Task: Look at the terraform script and check if terraform script is correct or what needs to be fixed.
Guardrails: Do not generate scripts if you do not know how to.

An example AWS CLI script pre-conversion comprises the following text:

fix_aws_cli = “aws s3api put-bucket-versioning −−bucket \${resourceName} −−region
\${region} −−versioning-configuration Status=Enabled”

A corresponding example Terraform script post-conversion comprises the following text:

```
terraform = resource “aws_s3_bucket_versioning” “s3_versioning” {
  bucket = “${var.bucket_name}”
  versioning {
    status = “Enabled”
  }}
```

The script converter 113 is used in embodiments where the response LLM 107 does not have extensive prior knowledge of a desired scripting language to include in responses to the user 101 and may be omitted when the desired scripting language is well known to the response LLM 107. The output validation module 111 populates a response template with the approved query response 118 (replacing any converted scripts with their converted versions) to obtain the validated user query response 120 and communicates the validated user query response 120 to the user 101.

Although the operations in FIG. 1 depict consolidated remediation of policy violations in response to a user query indicating one or more assets, in other embodiments the remediation system 190 can be configured with groups of related assets and, according to a schedule or other trigger, can generate consolidated sets of remediation actions for each group of related assets according to the schedule and stored sets of remediation actions for subsequent presentation to a user or administrator. The remediation system 190 can additionally or alternatively perform the consolidated sets of remediation actions according to a corresponding generated script.

The operations in FIG. 1 described using a RAG-based approach for augmenting prompts to the response LLM 107 using example scripts. A similar approach can be used for additional augmentations, such as by adding examples of sets of remediation actions and corresponding consolidated sets of remediation actions for similar assets, by augmenting prompts to the evaluation LLM with examples of correct and incorrect consolidated sets of remediation actions for similar assets, etc.

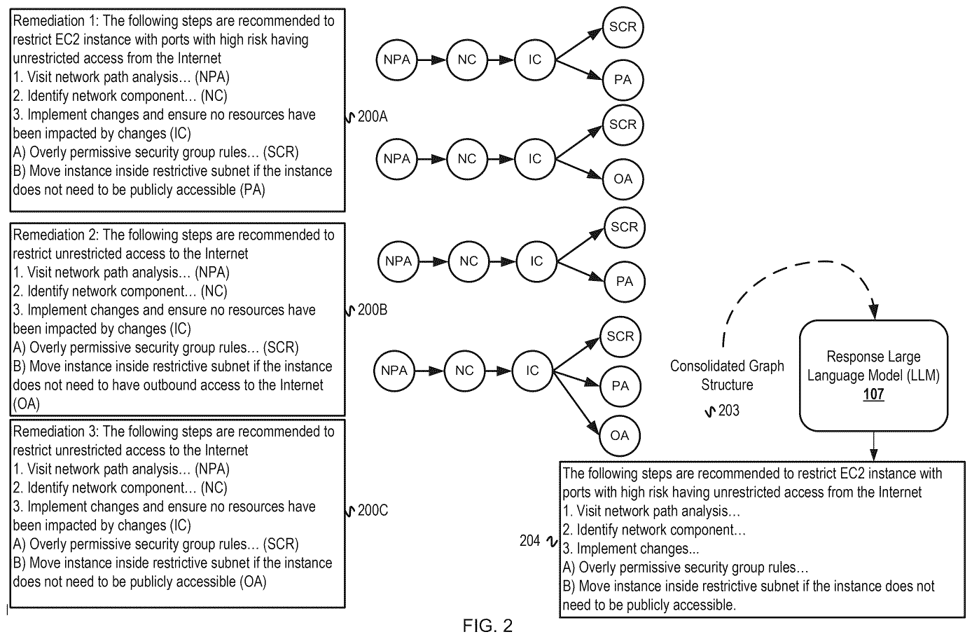

FIG. 2 is an illustrative diagram of example sets of remediation actions, example graph structures representing the sets of remediation actions, an example consolidated graph structure, and an example consolidated set of remediation actions. Example sets of remediation actions 200A, 200B, and 200C each comprise a description of a policy violation and subsequent remediation actions (truncated in FIG. 2 for brevity) that are abbreviated to match abbreviations occurring in an initial graph structure 201 and a consolidated graph structure 203. The initial graph structure 201 is depicted for illustrative purposes and may not be generated as part of generating the consolidated graph structure 203. The consolidated graph structure 203 is flattened and inserted into a prompt for the response LLM 107 that outputs a consolidated set of remediation actions 204.

The example set of remediation actions 200A comprises the text:
Remediation steps for Policy 1: The following steps are recommended to restrict EC2 instance with ports with high risk having unrestricted access from the Internet:
1. Visit network path analysis from Source to Destination and review the network path components that allow internet access. (NPA)
2. Identify network component on which restrictive rules can be implemented. (NC)
3. Implement changes and ensure no resources have been impacted due to these changes: (IC)
A) Overly permissive security group rules can be made more restrictive. (SCR)
B) Move instance inside a restrictive subnet if the instance does not need to be publicly accessible. (PA)

The example set of remediation actions 200B comprises the text:
Remediation steps for Policy 2: The following steps are recommended to restrict unrestricted access to the Internet:
1. Visit network path analysis from Source to Destination and review the network path components that allow internet access. (NPA)
2. Identify network component on which restrictive rules can be implemented. (NC)
3 Implement changes and ensure no resources have been impacted due to these changes: (IC)
A) Overly permissive security group rules can be made more restrictive. (SCR)
B) Move instance inside a restrictive subnet if the instance does not need to have outbound access to the internet. (OA)

The example set of remediation actions 200C comprises the text:
Remediation steps for Policy 3: The following steps are recommended to restrict unrestricted access from the Internet:
1. Visit network path analysis from Source to Destination and review the network path components that allow internet access. (NPA)
2. Identify network component on which restrictive rules can be implemented. (NC)
3. Implement changes and ensure no resources have been impacted due to these changes: (IC)
A) Overly permissive security group rules can be made more restrictive. (SCR)
B) Move instance inside a restrictive subnet if the instance does not need to be publicly accessible. (OA)

The initial graph structure 201 comprises a first graph structure corresponding to the example set of remediation actions 200A with a directed edge from an NPA node to an NC node, a directed edge from the NC node to an IC node, a directed edge from the IC node to an SCR node, and a directed edge from the IC node to a PA node. The initial graph structure 201 additionally comprises a second graph structure corresponding to the example set of remediation actions 200B with a directed edge from an NPA node to an NC node, a directed edge from the NC node to an IC node, a directed edge from the IC node to an SCR node, and a directed edge from the IC node to an OA node. Finally, the initial graph structure 201 additionally comprises a third graph structure corresponding to the example set of remediation actions 200C with a directed edge from an NPA node to an NC node, a directed edge from the NC node to an IC node, a directed edge from the IC node to an SCR node, and a directed edge from the IC node to a PA node. The consolidated graph structure 203 comprises a directed edge from an NPA node to an NC node, a directed edge from the NC node to an IC node, a directed edge from the IC node to an SCR node, a directed edge from the IC node to a PA node, and a directed edge from the IC node to an OA node. The consolidated graph structure 203 deduplicates the NPA, NC, IC, SCR, and PA nodes across the initial graph structure 201.

The consolidated set of remediation actions comprises the text:
The following steps are recommended to restrict EC2 instance with ports with high risk having unrestricted access from the Internet:
1. Visit network path analysis from Source to Destination and review the network path components that allow internet access.
2. Identify network component on which restrictive rules can be implemented.
3. Implement changes and make sure no other resources have been impacted due to these changes:
A) Overly permissive security group rules can be made more restrictive.
B) Move instance inside a restrictive subnet if the instance does not need to be publicly accessible.

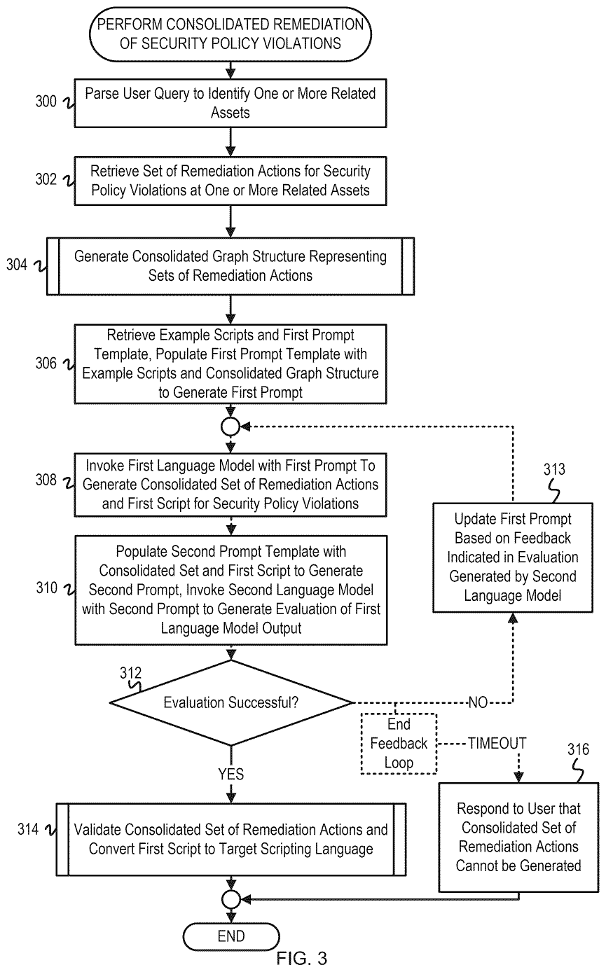

FIGS. 3-5 are flowcharts of example operations. The example operations are described with reference to a policy violation remediation system (“remediation system”) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for performing consolidated remediation of policy violations. The operations in FIG. 3 assume that a database stores descriptions of policy violations and corresponding sets of remediation actions for assets across an entity (e.g., an organization, a branch location, a region of a company, etc.). The sets of remediation actions can be generated for each type of policy violation by a domain-level expert.

At block 300, the remediation system parses a user query to identify one or more related assets to the user query. The user query is presented to the remediation system via a UI. Parsing the user query can depend on how the user query is input by a user. For instance, when the user query selects one or more assets or a group of assets indicated in checkboxes, dropdown menus, etc., parsing can comprise identifying assets selected by in these UI elements. When the user query is presented as a natural language question for a chatbot, the remediation system can prompt a language model to identify assets and/or groups of assets related to the user query.

At block 302, the remediation system retrieves a set of remediation actions for security policy violations at the one or more related assets. The remediation system queries the database storing security policy violation descriptions and corresponding sets of remediation actions with identifiers of the one or more related assets and/or a group identifier for the one or more related assets.

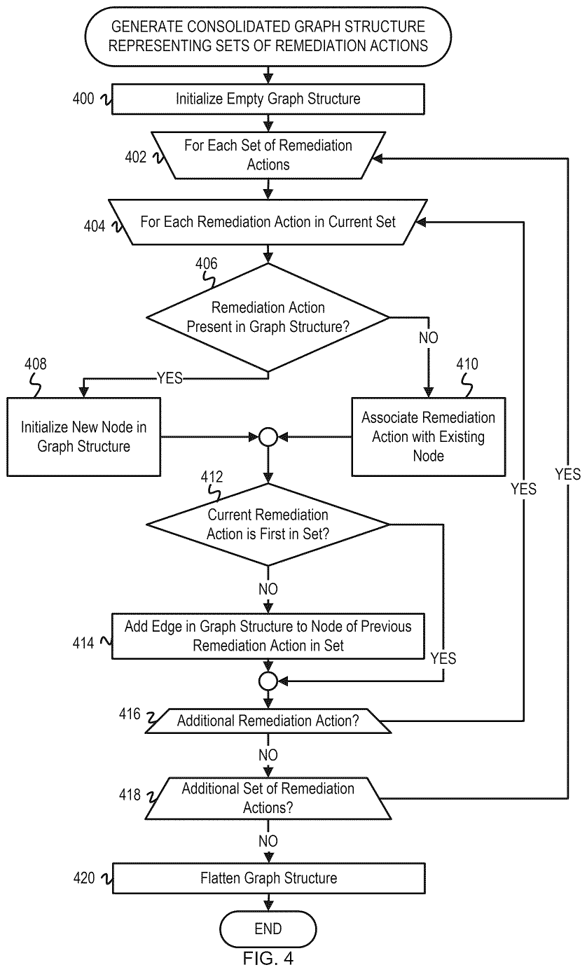

At block 304, the remediation system generates a consolidated graph structure representing the sets of remediation actions. The consolidated graph structure deduplicates duplicate remediation actions that occur multiple times across the sets of remediation actions for different security policy violations while preserving relative ordering of remediation actions within the consolidated graph structure as they occur in the sets of remediation actions. The operations at block 304 are depicted in greater detail in reference to FIG. 4.

At block 306, the remediation system retrieves example scripts and a first prompt template. The remediation system queries respective databases or other storage components of example scripts and prompt templates with characteristics of the one or more related assets that were indicated in the retrieval of sets of remediation actions at block 302. For instance, the example scripts can be retrieved by querying with identifiers of types of the one or more related assets and the first prompt template can be retrieved by querying with an identifier for a CSP of the one or more related assets. The remediation system then populates the first prompt template with the example scripts and the consolidated graph structure to generate a first prompt. The first prompt template comprises task instructions to act as an expert in remediation action summarization and script generation to generate a consolidated set of remediation actions and corresponding script using the consolidated graph structure and the example scripts. The task instructions can further comprise guardrail instructions such as to not generate scripts without knowledge of how to generate scripts and to preserve correct ordering of remediation actions.

The operations at blocks 308, 310, 312, and 313 occur as part of a feedback loop (as indicated by the dashed lines in FIG. 3) between a first language model and a second language model for generating a high-quality response to the user query. If a timeout trigger occurs during the feedback loop (e.g., a threshold number of iterations of the feedback loop occur), the feedback loop breaks and operational flow skips to block 316.

At block 308, the remediation system invokes a first language model with the first prompt to generate a consolidated set of remediation actions and a first script for remediating the security policy violations at the one or more related assets.

At block 310, the remediation system populates a second prompt template with the consolidated set of remediation actions and the first script to generate a second prompt. The remediation system then invokes a second language model with the second prompt to generate an evaluation of the output of the first language model. The second prompt template comprises task instructions to be an expert in examining summarizations of remediation actions and can specify a CSP of the one or more related assets.

At block 312, the remediation system determines whether the evaluation was successful as indicated in output of the second language model. If the evaluation was not successful, the feedback loop continues and operational flow proceeds to block 313. If the evaluation was successful, the feedback loop completes and operational flow proceeds to block 314.

At block 313, the remediation system updates the first prompt based on feedback indicated in the evaluation generated by the second language model. For instance, the remediation system can add a section to the first prompt indicating potential pitfalls when generating consolidated sets of remediation actions, as indicated in the evaluation. Operational flow returns to block 308.

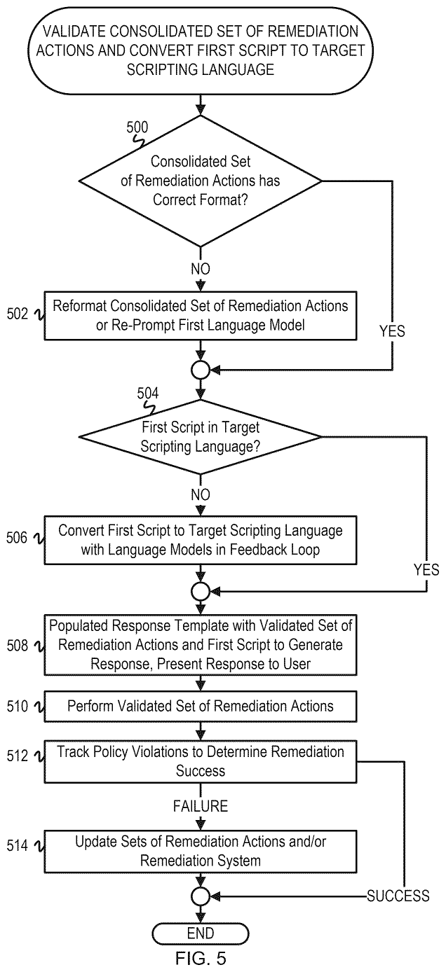

At block 314, the remediation system validates the consolidated set of remediation actions and converts the first script to a targeted scripting language. The operations at block 314 are described in greater detail in reference to FIG. 5. The operations in FIG. 3 terminate.

At block 316, the remediation system responds to the user with a response indicating that a consolidated set of remediation actions cannot be generated. The response can further indicate the (non-consolidated) sets of remediation actions for security policy violations at the one or more related assets.

The first and second language models can comprise LLMs (e.g., the OpenAI® GPT-4® LLM, the Google® Gemini LLM) trained to perform general language tasks. These language models can be further trained/fine-tuned (e.g., with conversational context) to the task of generating consolidated remediation actions and corresponding scripts in the case of the first language model and to evaluate consolidated remediation actions and corresponding scripts in the case of the second language model. More generally, the first and second language models can comprise any language model with the capability of responding to prompts.

FIG. 4 is a flowchart of example operations for generating a consolidated graph structure representing sets of remediation actions. The operations in FIG. 4 assume that sets of remediation actions have been obtained for security policy violations across a group of related assets identified in a user query.

At block 400, the remediation system initializes an empty graph structure. The empty graph structure will subsequently be populated to generate the consolidated graph structure. At block 402, the remediation system begins iterating through each set of remediation actions. The remediation system can iterate through sets of remediation actions in an arbitrary ordering, for instance an ordering of the sets of remediation actions in memory. At block 404, the remediation system begins iterating through remediation actions in the current set of remediation actions. These iterations start at the first remediation action in the current set and occur sequentially according to ordering of the remediation actions in the current set.

At block 406, the remediation system determines whether the current remediation action is present in the graph structure. Each node in the graph structure (if any) is labelled with a description of a corresponding remediation action. The remediation system searches for an exact or approximate match of the description of the current remediation action with descriptions at existing nodes in the graph structure. If the current remediation action is present in the graph structure (i.e., a match is found), operational flow proceeds to block 408. Otherwise, operational flow proceeds to block 410.

At block 408, the remediation system initializes a new node in the graph structure with a label comprising the description of the current remediation action, and operational flow proceeds at block 412. At block 410, the remediation system associates the current remediation action with the existing node in the graph structure (without initializing a new node). That existing node comprises a shared node across sets of remediation actions that deduplicates the remediation action.

At block 412, the remediation system determines whether the current remediation action is the first remediation action in the current set of remediation actions. If the current remediation action is the first remediation action, operational flow proceeds to block 416. Otherwise, operational flow proceeds to block 414.

At block 414, the remediation system adds an edge in the graph structure from the node in the graph structure corresponding to the previous remediation action in the current set of remediation actions to the node in the graph structure corresponding to the current remediation action. The edge is directed to point at the node in the graph structure corresponding to the current remediation action and represents/preserves sequential ordering of these nodes in the current set of remediation actions. The “previous” remediation action depends on hierarchical structure of the current set of remediation actions. For instance, when the current remediation action is below another remediation action in a hierarchy of the current set of remediation actions (i.e., the current remediation action is a sub-action of a different remediation action), then the “previous” remediation action is the parent remediation action of the current remediation action in the hierarchy. Otherwise, if the current remediation action is at the top level of the hierarchy, then the previous remediation action is the most recently occurring remediation action in the current set of remediation actions also at the top level of the hierarchy.

At block 416, the remediation system determines whether there is an additional remediation action in the current set of remediation actions. If there is an additional remediation action, operational flow returns to block 404. Otherwise, operational flow proceeds to block 418. At block 418, the remediation system determines whether there is an additional set of remediation actions. If there is an additional set of remediation actions, operational flow returns to block 402. Otherwise, operational flow proceeds to block 420.

At block 420, the remediation system flattens the graph structure to generate the consolidated graph structure. The remediation system performs a graph search algorithm (e.g., BFS or DFS) and, at each node visited in the graph search algorithm, stores the description of the corresponding remediation action (i.e., as indicated in the node label) in the flattening of the graph structure.

FIG. 5 is a flowchart of example operations for validating a consolidated set of remediation actions and converting a first script to a target scripting language. At block 500, the remediation system determines whether the consolidated set of remediation actions has a correct format. The remediation system determines whether the consolidated set of remediation actions is an ordered list of remediation actions. If the consolidated set of remediation actions has a correct format, operational flow skips to block 504. Otherwise, operational flow proceeds to block 502.

At block 502, the remediation system reformats the consolidated set or remediation actions or re-prompts the first language model to generate an additional consolidated set of remediation actions.

At block 504, the remediation system determines whether the first script is in a target scripting language. The target scripting language can comprise an infrastructure-as-code scripting language to facilitate remediation at corresponding assets, for instance an infrastructure-as-code scripting language that was used to configure the corresponding assets. If the first script is in the target scripting language, operational flow skips to block 508. Otherwise, operational flow proceeds to block 506.

At block 506, the remediation system converts the first script to the target scripting language with language models in a feedback loop. A converter language model attempts to convert the first script to the target scripting language and an evaluator language model determines whether the conversion was successful. The feedback loop continues until successful conversion or timeout criteria are satisfied (e.g., a threshold number of iterations of the feedback loop have occurred).

At block 508, the remediation system populates a response template with the validated set of remediation actions and the (possibly converted) first script to generate a response and presents the response to the user. The remediation system presents the response to the user via a UI where the user input a query for remediating assets, such as a UI of a cybersecurity software as a service application.

At block 510, the user or a separate cybersecurity component performs the validated set of remediation actions, for instance by running the script included in the response to the user.

At block 512, the remediation system tracks the policy violations to determine whether remediation was successful, i.e., the policy violations were resolved. If the remediation was successful, the operational flow in FIG. 5 is complete. Otherwise, the operational flow in FIG. 5 proceeds at block 514.

At block 514, the remediation system updates sets of remediation actions corresponding to the policy violations and/or itself for improved remediation at subsequent remediation iterations. For instance, the remediation system can update prompt templates for language models to be more descriptive, to include guardrails, etc.

### Variations

Any of the aforementioned language models and LLMs can comprise any off-the-shelf LLMs or, more generally, any foundation models capable of generating responses to prompts. The language models/LLMs can be one- or few-shot prompted and/or fine-tuned for their respective tasks with corresponding training data.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

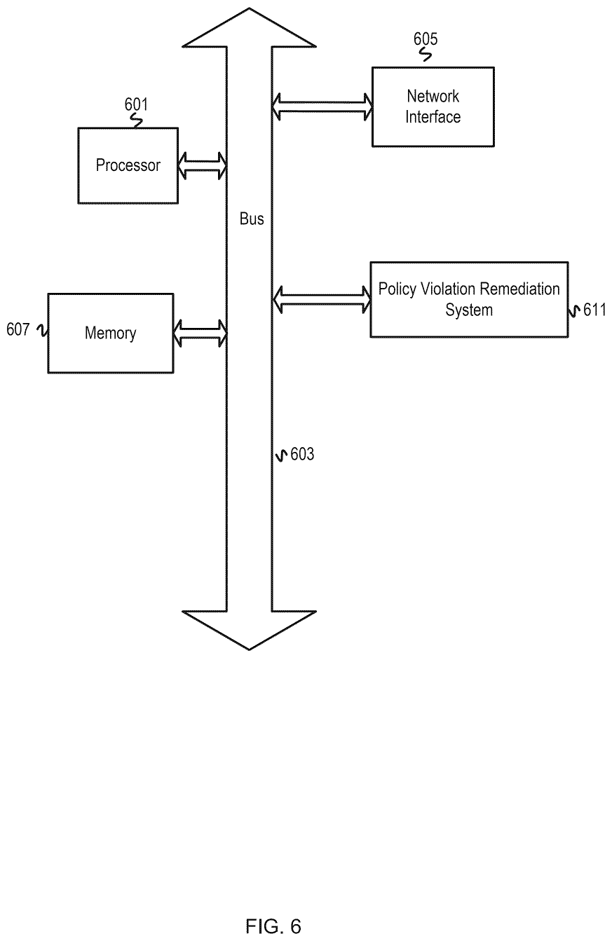

FIG. 6 depicts an example computer system with a policy violation remediation system. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes a policy violation remediation system (“remediation system”) 611. The remediation system 611 identifies one or more related assets indicated in a user query and retrieves sets of remediation actions for policy violations at those related assets. The remediation system 611 then generates a consolidated graph structure comprising a deduplicated representation of the sets of remediation actions and prompts a response LLM with the consolidated graph structure to generate a consolidated set of remediation actions and corresponding script. The response LLM engages in a feedback loop with an evaluation LLM until the consolidated set of remediation actions and script generated by the response LLM are correct. The remediation system 611 then validates the consolidated set of remediation actions and converts the script into a target scripting language, then responds to the user query with the validated/consolidated set of remediation actions and converted script. Although depicted as communicatively coupled to a single computer system, the remediation system 611 can comprise or communicate with multiple computer systems (e.g., cloud resources and/or cloud services) that may be disparately located when performing its various functionalities. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
retrieving a plurality of sets of remediation actions for each of a plurality of policy violations for security policies configured at one or more assets;
generating a graph structure with nodes representing remediation actions in the plurality of sets of remediation actions and edges indicating sequential ordering of remediation actions in the plurality of sets of remediation actions;
populating a first prompt template with the graph structure to obtain a first prompt; and
invoking a first language model with the first prompt to obtain in response a first set of remediation actions and a first script that performs the first set of remediation actions to resolve at least a subset of the plurality of policy violations.

2. The method of claim 1, wherein generating the graph structure comprises, for each set of remediation actions of the plurality of sets of remediation actions and for each remediation action in the set of remediation actions,
based on determining that the remediation action is not in the graph structure, initializing a node in the graph structure corresponding to the remediation action;
based on determining that the remediation action represents an existing node in the graph structure, associating the remediation action with the existing node in the graph structure; and
based on determining that the remediation action is not represented in a first of the set of remediation actions, adding a directed edge in the graph structure between the remediation action and a previous remediation action in the set of remediation actions.

3. The method of claim 1, further comprising:
populating second prompt template with the first set of remediation actions and the first script to obtain a second prompt;
invoking a second language model on the second prompt to obtain, in response, an indication of whether the first set of remediation actions and the first script are correct; and
based on the second language model indicating that at least one of the first set of remediation actions and the first script are incorrect,
updating the first prompt with an indication that at least one of the first set of remediation actions and the first script are incorrect to obtain a third prompt; and
invoking the first language model on the third prompt to obtain, in response, a second set of remediation actions and a second script that performs the second set of remediation actions.

4. The method of claim 3, further comprising repeatedly invoking the first language model to generate sets of remediation actions and scripts and invoking the second language model to evaluate the sets of remediation actions and scripts until a set of remediation actions and a script are correct.

5. The method of claim 3, wherein the second prompt template comprises a task instruction to evaluate whether the first set of remediation actions is correct and represents the graph structure.

6. The method of claim 1, further comprising retrieving one or more scripts for remediating policy violations, wherein retrieving the one or more scripts comprises retrieving scripts corresponding to one or more types of the one or more assets, wherein populating the first prompt template further comprises populating the first prompt template with the one or more scripts.

7. The method of claim 1, wherein the first prompt template comprises a task instruction to generate a set of remediation actions that represents the graph structure.

8. The method of claim 1, wherein the one or more scripts and the first script comprise command line interface commands.

9. The method of claim 8, further comprising:
populating a third prompt template with the first script to obtain a fourth prompt; and
invoking a third language model on the fourth prompt to obtain an infrastructure-as-code script that performs the first set of remediation actions.

10. A non-transitory machine-readable medium having program code stored thereon, the program code comprising instructions to:
retrieve a plurality of sets of remediation actions for each of a plurality of policy violations for security policies configured at one or more assets;
generate a graph structure that indicates each remediation action in the plurality of sets of remediation actions, wherein the graph structure comprises shared nodes for remediation actions common across the sets of remediation actions;
populate a first prompt template with the graph structure to obtain a first prompt; and
invoke a first language model with the first prompt to obtain in response a first set of remediation actions and a first script that performs the first set of remediation actions to resolve at least a subset of the plurality of policy violations.

11. The machine-readable media of claim 10, wherein the instructions to generate the graph structure comprise instructions to, for each set of remediation actions of the plurality of sets of remediation actions and for each remediation action in the set of remediation actions,
based on determining that the remediation action is not in the graph structure, initialize a node in the graph structure corresponding to the remediation action;
based on determining that the remediation action represents an existing node in the graph structure, associate the remediation action with the existing node in the graph structure; and
based on determining that the remediation action is not represented in a first of the set of remediation actions, add a directed edge in the graph structure between the remediation action and a previous remediation action in the set of remediation actions.

12. The machine-readable media of claim 10, wherein the program code further comprises instructions to:
populate second prompt template with the first set of remediation actions and the first script to obtain a second prompt;
invoke a second language model on the second prompt to obtain, in response, an indication of whether the first set of remediation actions and the first script are correct; and
based on the second language model indicating that at least one of the first set of remediation actions and the first script are incorrect,
update the first prompt with an indication that at least one of the first set of remediation actions and the first script are incorrect to obtain a third prompt; and
invoke the first language model on the third prompt to obtain, in response, a second set of remediation actions and a second script that performs the second set of remediation actions.

13. The machine-readable media of claim 12, wherein the program code further comprises instructions to repeatedly invoke the first language model to generate sets of remediation actions and scripts and invoke the second language model to evaluate the sets of remediation actions and scripts until a set of remediation actions and a script are correct.

14. The machine-readable media of claim 12, wherein the second prompt template comprises a task instruction to evaluate whether the first set of remediation actions is correct and represents the graph structure.

15. The machine-readable media of claim 10, wherein the program code further comprises instruction to retrieve one or more scripts for remediating policy violations, wherein the instructions to retrieve the one or more scripts comprise instructions to retrieve scripts corresponding to one or more types of the one or more assets, wherein the instructions to populate the first prompt template further comprises instructions to populate the first prompt template with the one or more scripts.

16. An apparatus comprising:
a processor; and
a machine-readable medium having instructions stored thereon that are executable by the processor to cause the apparatus to,
retrieve a plurality of sets of remediation actions for each of a plurality of policy violations for security policies configured at one or more assets;
generate a graph structure comprising nodes corresponding to deduplicated remediation action in the plurality of sets of remediation actions, wherein edges in the graph structure preserve sequential ordering of remediation actions in the plurality of sets of remediation actions;
populate a first prompt template with the graph structure to obtain a first prompt; and
invoke a first language model with the first prompt to obtain in response a first set of remediation actions and a first script that performs the first set of remediation actions to resolve at least a subset of the plurality of policy violations.

17. The apparatus of claim 16, wherein the instructions to generate the graph structure comprise instructions executable by the processor to cause the apparatus to, for each set of remediation actions of the plurality of sets of remediation actions and for each remediation action in the set of remediation actions,
based on determining that the remediation action is not in the graph structure, initialize a node in the graph structure corresponding to the remediation action;
based on determining that the remediation action represents an existing node in the graph structure, associate the remediation action with the existing node in the graph structure; and
based on determining that the remediation action is not represented in a first of the set of remediation actions, add a directed edge in the graph structure between the remediation action and a previous remediation action in the set of remediation actions.

18. The apparatus of claim 16, wherein the machine-readable medium further has stored thereon instructions executable by the processor to cause the apparatus to:
populate second prompt template with the first set of remediation actions and the first script to obtain a second prompt;
invoke a second language model on the second prompt to obtain, in response, an indication of whether the first set of remediation actions and the first script are correct; and
based on the second language model indicating that at least one of the first set of remediation actions and the first script are incorrect,
update the first prompt with an indication that at least one of the first set of remediation actions and the first script are incorrect to obtain a third prompt; and
invoke the first language model on the third prompt to obtain, in response, a second set of remediation actions and a second script that performs the second set of remediation actions.

19. The apparatus of claim 18, wherein the machine-readable medium further has stored thereon instructions executable by the processor to cause the apparatus to repeatedly invoke the first language model to generate sets of remediation actions and scripts and invoke the second language model to evaluate the sets of remediation actions and scripts until a set of remediation actions and a script are correct.

20. The apparatus of claim 18, wherein the second prompt template comprises a task instruction to evaluate whether the first set of remediation actions is correct and represents the graph structure.
